(19) United States
(12) Patent Application Publication
(10) Pub. No.: US 2006/0035690 A1
(43) Pub. Date: Feb. 16, 2006

(54) Method and apparatus for games using a three wheel carousel wheel

(76) Inventor: Jacob Y. Wong, Goleta, CA (US)

Correspondence Address: Roy L. Anderson, Esq.;LAW OFFICES OF ROY ANDERSON, 1010 North Central Avenue, Glendale, CA, 91202, US

(21) Appl. No.: 10/975,775

(22) Filed: Oct. 28, 2004

Related U.S. Application Data
(63) Continuation-in-part of application No. 10/941,513, filed on Sep. 15, 2004.
(63) Continuation-in-part of application No. 10/941,514, filed on Sep. 15, 2004.
Application No. 10/941,514 is a continuation-in-part of application No. 10/919,092, filed on Aug. 16, 2004.

(51) Int. Cl. G06F 19/00

(52) U.S. Cl. 463/1

(57) ABSTRACT

A game and method for playing games uses a carousel wheel contained in a storage medium (e.g., a compact disc or DVD) used to generate the carousel on a screen (e.g., a television screen when a DVD is used with a DVD player or a screen receiving input from a computer). The carousel wheel has an inner wheel divided into x inner wheel segments, each of which bears an inner wheel designation, a middle wheel divided into y segments, each of which bears a middle wheel designation, and an outer wheel divided into z outer equal segments, each of which bears an outer wheel designation, wherein y≧is x, z≧y and both y and z are divisible by x (e.g., x=6, y=12 and z=24). When the carousel wheel is spun by a player during a player's turn, the inner, the middle and the outer wheels rotate for a given spin so that once the carousel is spun, and each of inner, the middle and the outer wheels have rotated, said wheels will stop such that each of the inner wheel segments will align itself moving outwardly from the inner wheel with (y÷x) of the middle wheel segments and (z÷x) of the outer wheel segments. The carousel wheel is used with physical objects, such as a board and markers, to create a board game atmosphere and experience.

### NOTICE OF RELATED APPLICATIONS

This application is a continuation-in-part of U.S. patent application Ser. Nos. 10/941,513 and 10/941,514, filed Sep. 15, 2004, which are continuation-in-parts of U.S. patent application Ser. No. 10/919,092, filed Aug. 16, 2004, the disclosures of which are specifically incorporated herein by reference.

### FIELD OF THE INVENTION

This invention is in the field of children's games. It is mainly designed for children ages 4 and up and their family members or friends getting together to play a game for entertainment.

### BACKGROUND OF THE INVENTION

Today we are living amid the dawning of the so-called Information Age, propelled by the amazing advancements in silicon micro-chips, microprocessors, the accompanying smart software and particularly the advent of the Internet. The omnipresence of cellular or mobile phones, wireless notebook computers, super-sophisticated electronic games and digital cameras etc. have profoundly changed the way of life for the populace, particularly in the United States, just within the past decade. Fortunately for children of ages 4-9, they are still very much under the tender loving care of their parents and the influence of the onslaught of the bad influence from the Information Age on them is still rather minimal. Notwithstanding, some of today's children age 4 and up already know how to turn on a computer, load application software, play electronics games on the computer and sometimes even get online to websites on the Internet. They sometimes even act as tutors to their parents when it comes to setting up the computer to play electronic games or execute various application software programs.

On the other hand, as far as traditional board games go, such as Monopoly®, Scrabble®, Life®, etc., to name just a few, they are still being played but by fewer and fewer people especially among young adults and children over the age of 10. These games are now considered by most of them as “tired”, “boring” and “old-fashioned” because they do not involve modern day technologies like using computers or TV's (X-Box®) or Play Station 2®)). The fact of the matter is that even though most parents do not want their children 7 years or younger to play the often violent and tasteless electronic games, there are not many choices for them because most board games for that age group still do not embrace the use of modern day electronics but remain as manually or mechanically inclined using only plastic mats, paper boards, cards, chips, paper money and dice etc.

It is therefore the principal objective of the present invention to introduce new and wholesome games for children ages 4-8 not only with traditional values such as those mentioned earlier, but also a visually appealing, multicolor spinning carousel displayed on the TV screen or the Laptop or PC monitor. The game comes with a DVD or CD for respectively loading the simple game-playing software onto the TV screen through the omnipresent DVD player in people's homes nowadays or a Laptop or PC monitor using the CD driver. Thus, the presently invented game apparatus reaches over to the so-called Information Age with its modern day electronic gadgetries such as the TVs, DVD players, PC's, Laptop computer etc. On the other hand, the virtue of the old board games is preserved in that the whole family or children themselves can now gather together physically (not through an electronic network) in front of the TV set and play the presently invented game with the usual familiar game accessories like cards, paper money, chips etc.

### SUMMARY OF THE INVENTION

The present invention is generally directed to a new game and method for playing games that use a carousel wheel contained in a storage medium (such as a compact disc or DVD) containing a game program used to generate the carousel on a screen (which can be a television screen when a DVD is used with a DVD player or a screen receiving input from a computer). The carousel wheel has an inner wheel divided into x inner wheel segments, each of which bears an inner wheel designation, a middle wheel divided into y segments, each of which bears a middle wheel designation, and an outer wheel divided into z outer equal segments, each of which bears an outer wheel designation, wherein y is greater than or equal to x, z is greater than or equal to y and both y and z are divisible by x, and, wherein x can be 6, y can be 12 and z can be 24. When the carousel wheel is spun by a player during a player's turn, the inner, the middle and the outer wheels rotate for a given spin so that once the carousel is spun, and each of inner, the middle and the outer wheels have rotated, said wheels will stop such that each of the inner wheel segments will align itself moving outwardly from the inner wheel with (y divided by x) of the middle wheel segments and (z divided by x) of the outer wheel segments.

In a first, separate group of aspects of the present invention, a game is disclosed that uses a board with twenty different indicia (such as animals or dinosaurs) divided into five groups, multiple sets of twenty colored markers, each of the markers bearing a different one of twenty different indicia and its own designation (such as a number) and a storage medium containing a game program used to generate a screen with the carousel wheel which can be spun. The inner wheel of the carousel contains five designations that match each of the five groups (that can be linked by a common characteristic revealed in the inner wheel) plus a sixth designation, the middle wheel of the carousel contains ten designations (that can include a second common characteristic associated with a group) of which two designations match each of the five groups plus two additional designations and the outer wheel has twenty-four designations, of which twenty match the twenty different indicia.

In a second, separate group of aspects of the present invention, two or more players take turns spinning the carousel wheel and attempt to collect markers based upon their spins. Once a designated player has spun the carousel wheel, the turn passes to another player unless there is an action match based upon a preselected group of (one) inner, (two) middle and (four) outer wheel designations for the designated player for the designated player's spin; if there is an action match, a set of action match rules is applied to determine whether the designated player gains or loses one or more markers from the spin. After the spin is concluded, play continues to another player if the designated player has not accumulated a winning collection of markers. The action match results in an award match when a designation from one of five groups in the inner wheel is matched with a designation in the middle and outer wheels, and then a marker matching the outer wheel designation that was matched is awarded. The action match results in a misfortune match when a sixth designation of the inner wheel is matched in the middle wheel, in which case the designated player looses any markers that match any outer wheel designations in the preselected group for that player and spin. The action match results in a special misfortune match when the preselected group contains the sixth inner wheel designation, one of the two middle wheel designations that are not matched to any of the five groups and one of the four outer wheel designations that are not matched to any of the five groups; in this situation, the designated player must either surrender all of the designated player's markers or is allowed to choose one or more markers from one or more of the other players. Also, the players can be allowed to select one or more rules to be applied when there is an action match.

Accordingly, it is a primary object of the present invention to provide improved games and methods for playing games that utilize a carousel wheel with three wheels.

These and further objects and advantages will be apparent to those skilled in the art in connection with the drawings and the detailed description of the invention set forth below.

### BRIEF DESCRIPTION FO THE DRAWINGS

FIG. 1. A carousel for playing the “Zoo or Bust!” game embodiment of the present invention.

FIG. 2. A table showing the integer number assignment from 1 to 20 of the zoo animals in the zoo of the “Zoo or Bust!” game embodiment of the present invention.

FIG. 3. A layout of the zoo ground depicting the five different habitats for the five different animal groups of the “Zoo or Bust!” game embodiment of the present invention.

FIG. 4. Flowchart for the playing sequence and procedures for the “Zoo or Bust!” game embodiment of the present invention.

### DETAILED DESCRIPTION OF THE INVENTION

In accordance with an especially preferred embodiment of the present invention, a game apparatus is described that is fun for young children, as well as for older members of a family, and even adults. The game apparatus is designed to play like a board game, where multiple players or members of a family can be gathered around the game in a social atmosphere, but still capture some of the excitement and interest found in electronic games. Thus, the present invention uses physical objects, such as markers and/or a board, in addition to a computer program that generates a “carousel wheel” with three different wheels, one being an innermost wheel, one being a middle wheel and one being an outermost wheel, each of which is divided into a number of segments, with each segment bearing one or more designations. When the carousel wheel is “spun” for a given player's turn, the carousel wheel is “electronically spun” so that each of the wheels has had movement, thus simulating a physical carousel having three wheels that are spun for a turn, but with all the advantages of a colorful electronic screen display. When a player's spin is complete, and the wheels have stopped their “spinning,” the resultant display is used to determine the play of the game, based upon an alignment of the various wheel segments. Thus, rather than using a spinner, or dice, to determine the play of the game, the game uses the results of an alignment of the three wheels of the carousel. And, in contrast to purely electronic games, once the carousel has been spun, the players then use the results to interact with the physical objects of the game, which helps create a return to a “board game” atmosphere with all of its resultant charm and player interaction.

The Applicant will now turn to an explanation of an especially preferred embodiment of the present invention which has been developed and which the Applicant intends to sell under the trademark “Zoo or Bust!” Although the following description sets forth the rules for playing the “Zoo or Bust!” game in detail, it should be readily apparent to one skilled in the art that the following description is being set forth as simply one example of a game that can be designed and played using the present invention, and that many additional games can be designed using a three wheel carousel as taught herein. Accordingly, the following detailed description is not meant to limit the present invention, but to fully set forth a new game, “Zoo or Bust!,” and methods for playing the game.

The “Zoo or Bust!” game is designed for two to four players to play. The game concept is based upon the fact that some pranksters have managed to break into the zoo and let all the animals escape from their cages or habitat surroundings. The object of the game is for the players to round up all the escaped animals into their respective groups and put them back into the zoo where they belong. The zoo animals are divided up into five groups that bear a common characteristic, and they are, respectively, the Giants (Elephant, Giraffe, Rhino and Hippo), the Bears (Kodiak Bear, Polar Bear, Panda bear and Black Bear), the Big Cats (Lion, Tiger, Leopard and cougar), the Reptiles (Crocodile, Python, Anaconda and Iguana) and the Primates (Gorilla, Orangutan, Pygmy Chimp and Monkey. However, in order to catch all these different zoo animals, one must use the right tools to get the job done. For example, in order to catch the Giants group of animals like the Elephant, Giraffe etc., one must resort to using the stun gun to first get them unconscious before moving them. Otherwise they are just too big and heavy to handle, not to mention the fact that they are also dangerous when one forces them to act against their will. Therefore the players must first make themselves knowledgeable about what tools to use in order to catch the different type of zoo animals that have escaped.

But in addition to the zoo animals scattered all around out there, still another group of “animals” exists and they are the thieves. Their objective is to steal the zoo animals and ship them illegally out of the country for money. Thus the players must not only pay attention to catching the animals, they must also watch out for the thieves because they will try to steal the animals away every chance that they have even though the animals have been recaptured and are ready to be taken back to the zoo.

To start the game, every player is handed 20 poker chips (or “markers”). Each of these chips has the picture of an animal on one side and a number on the other to which the animal is assigned. The color of the chips for each player is different and the 20 chips represent all the 20 animals that have escaped from the zoo. In front of the players is also a zoo map having five living quarters housing respectively the five groups of animals normally residing inside the zoo. Every time a player is successful in recapturing an animal (see below), the player will first find the chip corresponding to that animal in the player's possession and place it in the particular living quarter where the animal belongs. However, when one of the player's recaptured animals (already back at the zoo) is stolen by the thieves, the player will have to retract that particular chip representing the recaptured animal back to his pile of chips in his possession. In the event that all the player's recaptured animals are stolen, the player will have to retract all the chips that the player has placed inside the zoo back to the player's possession.

There are many ways that this game can be played. The first way is called the “My Favorite Animal” game. Prior to the game, each player can declare one animal that is his or her favorite. Each player selects and places in front the chip that has the picture of his or her favorite animal on it. Whosoever captures his or her favorite animal first wins the game. A second way to play this game is to set a number for the animals to be successfully recaptured. This number could be six, ten or any number. Whosoever recaptures the number of animals decided prior to the game wins. A third way to play the game is to declare a player a winner when he or she recaptures all the four animals in any particular group of animals inside the zoo. For example, the first player who captures all the animals in the Reptile group, namely the Crocodile, the Python, the Anaconda and the Iguana, or in any one of the other four groups will be the winner. As a matter of fact, each player can take turns to declare his or her winning criterion for the game just like playing the poker game for the adults.

The ways how a player recaptures a zoo animal or how recaptured animals can be stolen by thieves will be determined by the spinning of a carousel appearing on a TV screen or the monitor of a PC or Laptop computer. This will be discussed in detail below when a description of the current invention will be presented along with the helps of the accompanying figures.

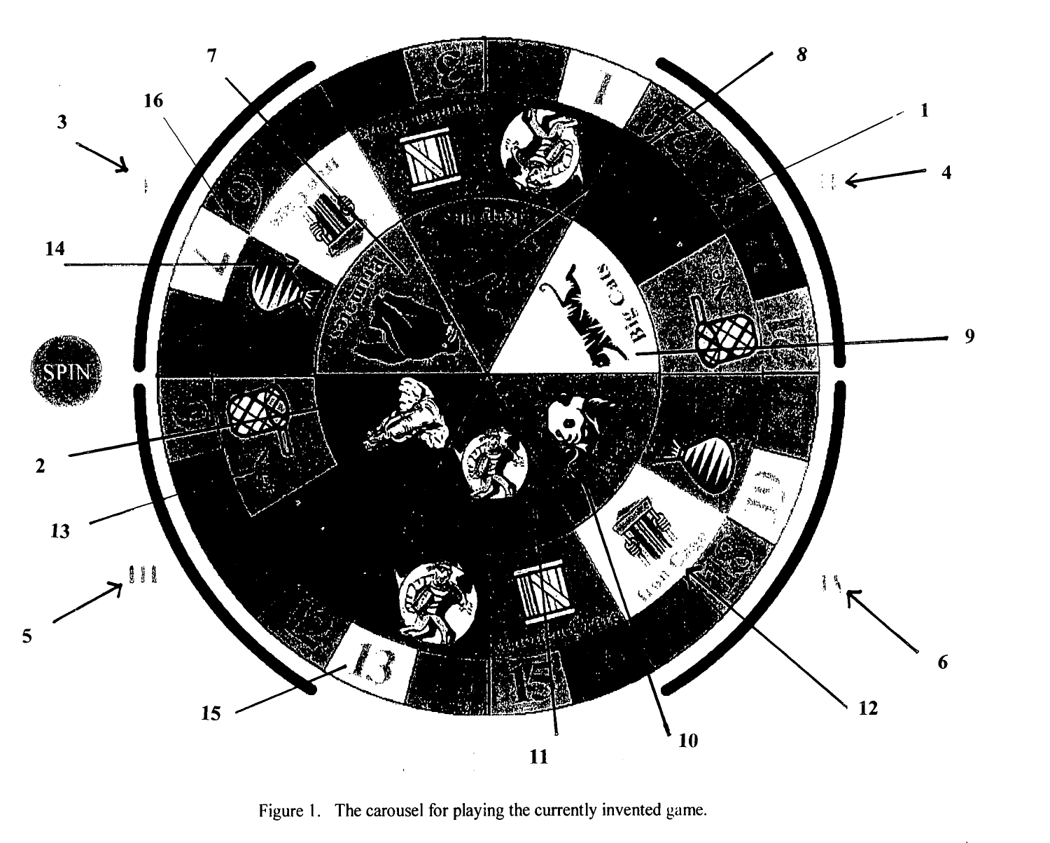

FIG. 1 shows the carousel which is a composite structure of three wheels and the players' respective pointers used to play the currently invented game. The minimum number of players playing this game is two (2) and the maximum of four (4).

The innermost wheel 1 is called the “Animal Group” wheel or the 1^{st} wheel. This wheel has six (6) equal segments or wedges each occupying 60 degrees of angular span out of a total of 360 degrees for a full circle. Starting with wedge 2 or “Giants” and going clockwise, the wedges are respectively “Primates” 7, “reptiles” 8, “Big Cats” 9, “Bears” 10 and “Thieves” 11. When this wheel 1 is spun, the stopping position of this wheel at the players' respective pointers 3, 4, 5 or 6 always ends up at the middle of a particular wedge, e.g. wedge 7 or “Primates” (for pointer 3 in this case shown). In other words, each wedge like 7 (“Primates”) of the 1^{st} wheel always encompasses two contiguous truncated wedges of the 2^{nd} or Capturing Tools” wheel (in this case “Bag” and “Iron Cage”) and 4 truncated wedges of the 3^{rd} or “Zoo Animals” wheel (in the case “5′, “6”, “7” and “8”). The 2^{nd} and 3^{rd} wheels will be described momentarily. Also for this wheel, the “Primates” 7 is colored “peach”, “the “Reptiles” 8 “green”, the “Big Cats” 9 “yellow”, the “Bears” 10 “pink”, the “Thieves” 11 “red” and the “Giants” 2 “blue”.

The middle wheel (or 2^{nd} wheel) 12 is the “Capturing Tools” wheel. This wheel has twelve (12) equal segments or wedges each occupying 30 degrees of angular span out of 360 degrees for a full circle. Because of the fact that the wedges of this wheel are overshadowed by the wedges of the 1^{st} wheel, these wedges are truncated. Starting with wedge 13 or “Net” and going clockwise, the truncated wedges are occupied respectively by “Bag”, “Iron Cage”, “Wooden Crate”, “Thief”, “Stun Gun”, “Net”, “Bag”, “Iron Cage”, “Wooden Crate”, “Thief” and “Stun Gun”. When this wheel is spun, its stopping position at the players' respective pointers 3, 4, 5, or 6 always ends up at the adjoining side 14 between two truncated wedges (in this case “Iron Cage” and “Bag” for pointer 3). In other words, as pointed out before, two truncated wedges “Iron Cage” and “Net” of this wheel always line up exactly with one wedge of the 1^{st} wheel (in this case the “Primates” wedge). In addition, the wedge “Net” of this wheel is colored “peach”, the wedge “Bag” “green”, the wedge “Iron Cage” “yellow”, the wedge “Wooden Crate” pink”, the wedge “Thief” red” and the wedge “Stun Gun” “blue” respectively. The coloring and selection of the various designations of the middle wheel are matched to the coloring of the various designations of the inner wheel such that there are two matching inner wheel color designations for each color designation of the inner wheel.

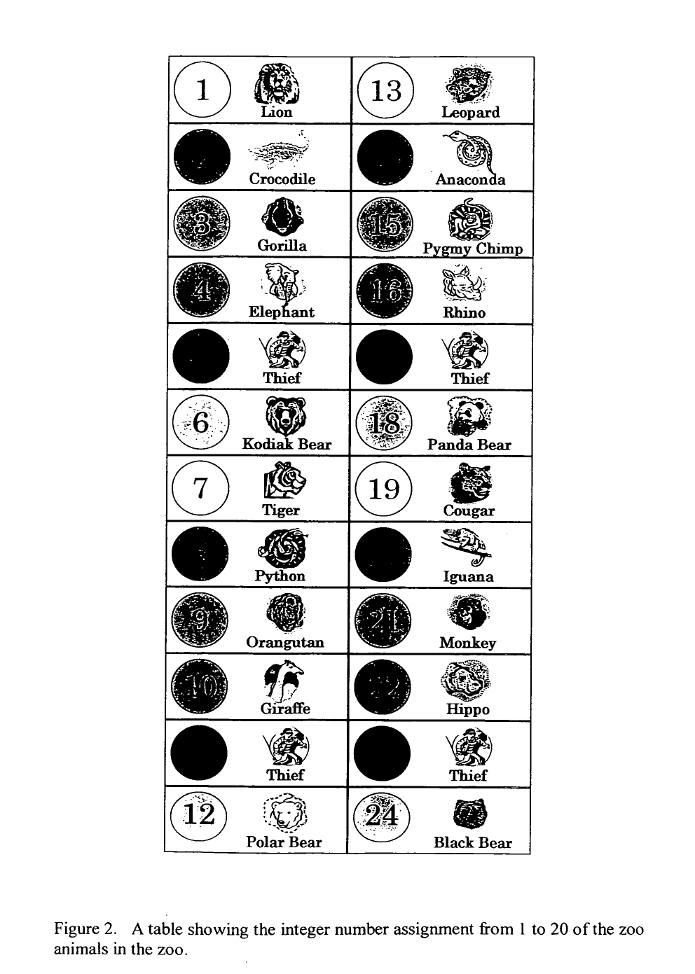

The outermost wheel 15 is the “Zoo Animals” wheel or 3^{rd} wheel. This wheel has twenty-four (24) equal segments or wedges each occupying 15 degrees of angular span out of 360 degrees for a full circle. Each wedge of this wheel is also truncated because of the overshadowing by the 1^{st} wheel 1 and the 2^{nd} wheel 12 and carries a zoo animal represented by an integer number. There are a total of 24 integer numbers in the 3^{rd} wheel or 24 zoo animals (including the animal “Thief”!) arranged from “1” to “24” consecutively going counterclockwise. FIG. 2 is a table showing the correspondence between the zoo animals and their assigned integer numbers. For example, the zoo animal “Lion” has the integer number “1” and the “Crocodile” integer number “2” etc. When this wheel is spun, its stopping position at the players' respective pointers 3, 4, 5 or 6 always ends up at the middle divider 16 of a group of numbers (in this case “5”, “6”, “7” and “8” for pointer 3). In other words, as pointed out before, four contiguous truncated wedges of the “Zoo Animals” or 3^{rd} wheel 15 always lined up exactly within two contiguous wedges (“Bag” and “Iron Cage”) of the “Capturing Tools” or 2^{nd} wheel 12 and one wedge (“Primates”) of the “Animal Group” or 1^{st} wheel 1. In the 3^{rd} wheel, the numbers “1”, “7”, “13” and “19” are colored “yellow”, the numbers “2”, ““8”, “14” and “20” are colored “green”, the numbers “3”, “9”, “15” and “21” are colored “peach”, the numbers “4”, “10”, “16” and “22” are colored “blue” the numbers “5”, “11”, “17” and “23” are colored “red” and the numbers “6”, “12”, “18” and “24” are colored “pink”. The coloring and selection of the various designations of the outer wheel are matched to the coloring of the various designations of the inner and middle wheels such that there are four matching outer wheel color designations for each color designation of the inner wheel. Also, with the coloring and numbering scheme just described, it is apparent that no more than one animal from any one given group of animals can appear for any player's point for any given spin.

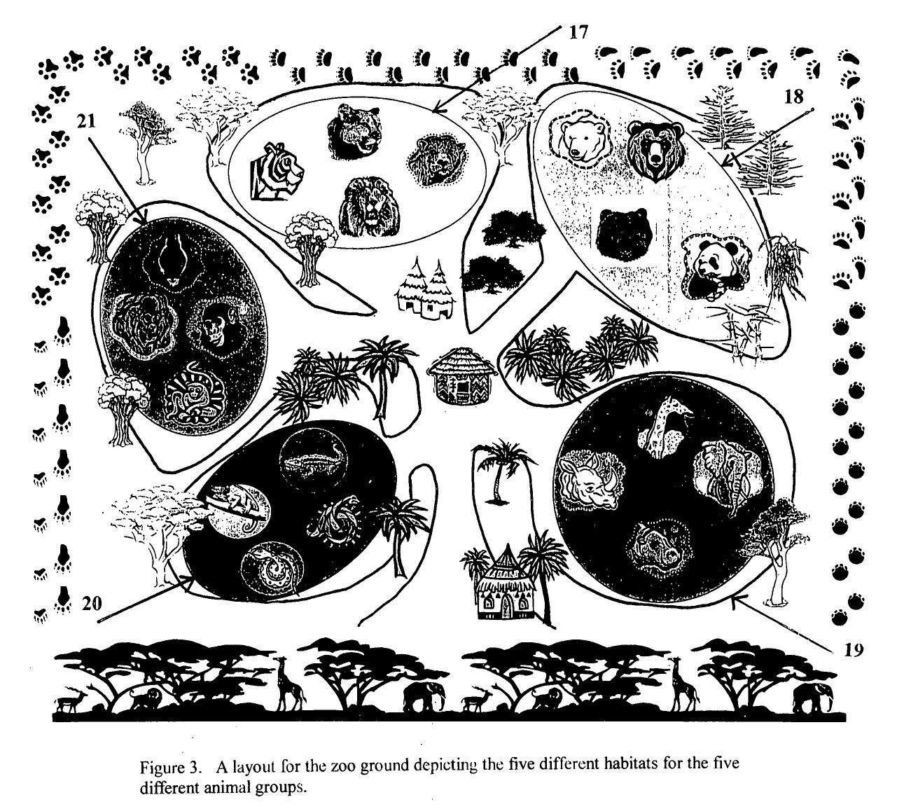

FIG. 3 shows the layout of a board showing the zoo ground comprising five habitat areas each housing a particular animal group. Starting from the top of FIG. 3, habitat 17 is for the Big Cats, habitat 18 is for the Bears, habitat 19 is for the Giants, habitat 20 is for the Reptiles and habitat 21 is for the Primates. As the zoo animals are recaptured by the players, they (represented by the colored chips) will be respectively placed back in the five habitats. Since players are equipped with the zoo animal chips of different colors, there should no mixed-up or confusion as to which player has recaptured what zoo animals in a particular habitat. Also, while the present invention is described by reference to a board, it is not necessary that the “board” be an actual board or made of cardboard or paper material; if desired, the “board” can be made of plastic or any other material on which printed material can be affixed and on which markers can be placed, although it is especially preferred that the “board” be of cardboard construction to harken back, and thus link, to the so-called “board games” of old.

The order to play this game among the players is not an important factor in the outcome of the game. Any player can start the game and the other players simply take turn in a clockwise or counterclockwise direction. Prior to the start of the game, each player is given a complete set of zoo animal chips (20 in number) of a particular color. On one side of the chip is the zoo animal picture with its name on it and on the other side an integer number to which that particular zoo animal is assigned. When a player successfully captures a zoo animal, he or she has to first find the animal chip in the player's possession before placing it in the correct animal habitat where the animal belongs. Other players do the same thing. This goes on as the game progresses until a player wins when he or she captures the animals according to the pre-agreed game winning criterion discussed earlier.

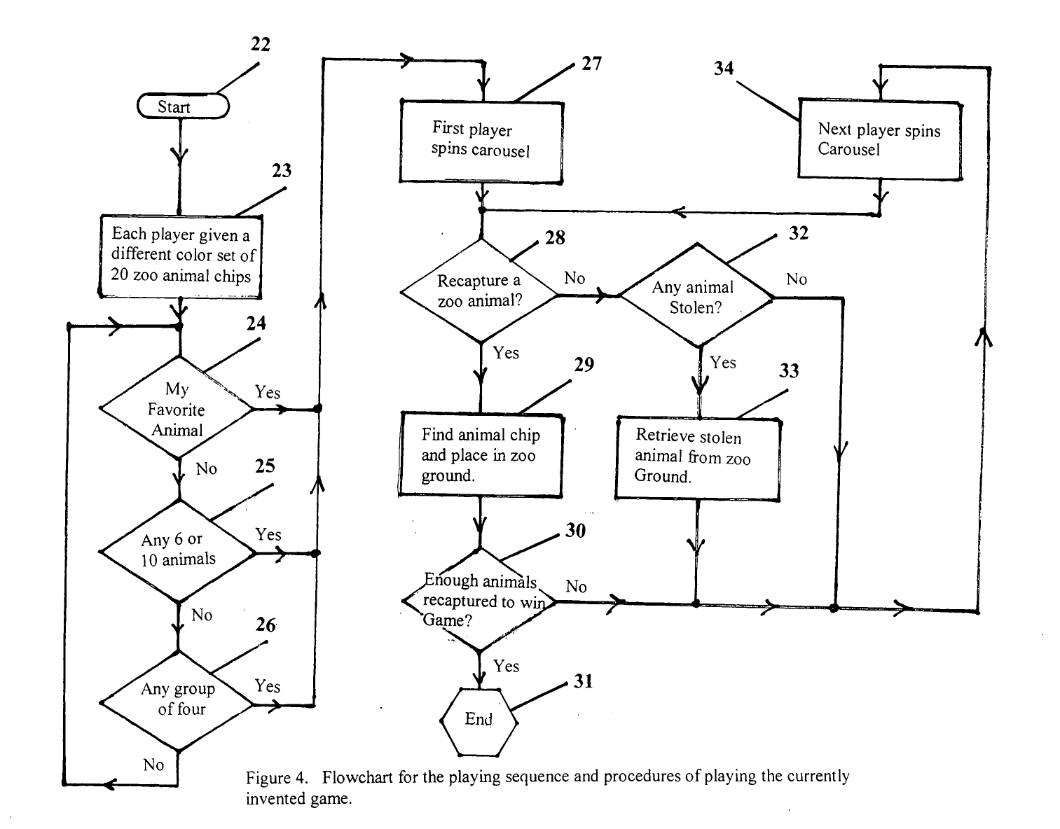

FIG. 4 shows a flowchart depicting the playing order and procedures of how the game is being played among the four players. As the game starts at flowchart element 22 (FE-22), each player (assuming there are four or maximum number of players) will be given a set of 20 zoo animal chips as indicated in FE-23. The next order of business is for the players to decide what is the winning criterion for the game (FE-24 to FE-26). For example, FE-24 could be “My Favorite Animal”), FE-25 could be “Any 6 or 10 Animals” and FE-26 could be “Any Group of Four” etc.

Then at FE-27, the first player spins the carousel. After all three wheels of the carousel have come to a stop, FE-28 tests whether a zoo animal is successfully recaptured. If it is, the player must first find the corresponding animal in the player's chip possession and then place it in the appropriate animal group habitat in the zoo ground (FE-29). Next, the player goes on to test whether he or she has successfully met the criterion to win the game in FE-30. If the winning criterion is met (FE-24 to FE-26), the game ends at FE-31. If no zoo animal is successfully recaptured, the player has to test whether one or more of his or her earlier recaptured animals are stolen by thieves in FE-32. If one or more animals are stolen, the player has to retrieve those animal chips from the appropriate animal group habitat in the zoo ground back to the player's possession as indicted in FE-33.

If the game does not end in FE-31, then the next player will spin the carousel as indicated in FE-34. Basically the same tests are conducted for the player (FE-28 through FE-33) before the next player is set to spin or the game ends at FE-31. In this way the game progresses orderly until one of the players wins.

To better illustrate the “Zoo or Bust!” game, the game will now be described by a set of directions designed to teach users of the game how to play the game without reference to FIGS. 1-4 or the numerals set forth therein. Instead, the instructions make reference to the actual “Zoo or Bust!” carousel and game board, both of which have already been described, and are illustrated in FIGS. 1 and 3.

Instructions for Playing the Game of “Zoo or Bust!”

Number of Players: 2 to 4 players

Loading the Game DVD or CD Disc

The game may come with a DVD disc, a CD disc or both discs. For the DVD, simply load disc onto the DVD player. Follow instructions that appear. For the CD, load it onto any PC or Laptop computer using its CD Driver. A motionless carousel will appear on the monitor screen ready for action. To start the carousel spinning, simply hit the “Space Bar” of the keyboard or place the cursor on the “Spin” button on the monitor and then “click” the mouse. The carousel stops automatically assuming a random position after every spin. Press “ESC” to exit game program. Note: In the unlikely situation that the carousel wheels do not line up properly, restart by pressing the “ESC” button and then the “Space Bar”.

Before the Game Starts . . .

Every player receives 20 zoo animals chips of a different color. These are the animal chips used to declare your “Favorite Animal” (see below) or to place one or more on the appropriate habitats of the zoo ground board as the animals are being re-captured during the game.

Carousel Pointer Assignment to Players

A player's carousel pointer is defined as the marker that determines the position of the Zoo Carousel at the end of a spin. It is a circular arc located of the carousel and labeled as either “I”, “II”, “III” or “IV”.

The first player to play will be assigned carousel pointer #1 (the circular arc outside of the carousel labeled “I”) followed by the second player with pointer #2 (the circular arc outside of the carousel labeled “II”) etc.

Order of Play for the Players

The order of play for the players is not important in the playing of the game Zoo or Bust! The game can start with any player.

Determining What Game (Winning Criterion) to Play

The “Zoo or Bust!” is unique in that every player has the right to declare his or her favorite “winning criterion” when it is the player's turn to start a new game. We recommend that each player declares a different winning criterion in order to maximize the enjoyment of playing the game.

There are many winning criteria a player can declare to play the game. The following is a recommended list of them. A player can even select two criteria, especially one of the two is a Bonus criterion, and declare to play Either . . . Or . . . .
Any Six . . . A player who first re-captures any 6 animals wins.
My Favorite Animal . . . This is a Bonus criterion. Each player declares his or her favorite animal before the game starts. The player who first recaptures his or her declared favorite animal wins.
Any Ten . . . A player who first re-captures any 10 animals wins.
Any Group of Three . . . A player who first re-captures any three animals in any one of the five animal groups wins.
Any 2 Groups of Three . . . Any player who first re-captures any three animals in any two of the five animal groups wins.
Any 3 groups of Three . . . Any player who first re-captures any three animals in any three of the five animal groups wins.
Any Group of Four . . . Any player who first recaptures all four animals in any one of the five animal groups wins.
Any 2 Groups of Four . . . Any player who first re-captures all four animals in any two of the five animal groups wins.
Any 3 Groups of Four . . . Any player who first re-captures all four animals in any three of the five animal groups wins.
   How the Game is Played

The game starts with the first player spinning the Zoo Carousel by 1) for DVD, pressing the “Play” button on the remote control unit of the DVD player and then pressing the “Pause” button to stop it; or 2) for CD, pressing the Space Bar” or placing the cursor on the “Spin” button of the monitor and then “clicking” the mouse. The random position of the carousel as indicated by the player's pointer (circular arc) after it stops (automatically for CD only) will determine how successful he is in re-capturing any of the escaped zoo animals.

Set of Rules for Playing the Game

There are two sets of rules players can adopt for playing the game. Set ONE is for the average players seeking maximum fun and excitement while Set TWO is for players who love to have more challenges. Try playing both sets of rules and see which set you like better.

Set One:

Rule No. 1: Except for the Animal Group “Thief”, if there is a color match among all three wheels, e.g. “Big Cats” (Yellow) in the Animal Groups wheel, “Iron Cage” (Yellow) in the Capturing Tools wheel and “(1) Lion” (Yellow) in the Zoo Animals wheel, then the Lion is considered to be recaptured. The same holds true for all the other Animal Groups, Capturing Tool Groups and Zoo Animals.

Rule No. 2: If a player's final Zoo Carousel position, as determined by his pointer, lands on “Thieves” of the Animal Groups wheel which has “Red” color, nothing happens if the “Thief” of the Capturing Tools wheel is not lined up with the pointer.

Rule No. 3: If the “Thieves” of the Animal Groups wheel and the “Thief” (Red) of the Capturing Tools wheel lined up simultaneously with the player's pointer, then all four zoo animals of the outermost wheel lining up with the other two wheels are subjected to escape once again. But the zoo animals affected are only those captured earlier by the current player who last spun the Zoo Carousel.

Rule No. 4: If the “Thief” of all three wheels lined up with the player's pointer, the player has the right to snatch a zoo animal of his choice from one of the other players.

Rule No. 5: If a player re-captures an animal which is already captured by him or her earlier, the player can repeat spinning the carousel a second time.

Set Two:

All rules are the same as SET ONE except Rule No. 4.

Rule No. 4: If the “Thief” of all three wheels lined up with the player's pointer, all the zoo animals captured earlier by the current player are subjected to escape.

Glossary of Terms Used in Playing the Game

The inner most wheel (1^{st} wheel) is the Animal Groups wheel.
The middle wheel (2^{nd} wheel) is the Capturing Tools wheel.
The outermost wheel (3^{rd} wheel) is the Zoo Animals wheel.
The composite structure of all three wheels is called the Zoo Carousel.
There are six Animal Groups. They are respectively “Big Cats”, “Reptiles”, “Primates”, “Giants”, “Thieves” and “Bears”. There are four members in each of the six Animal Groups.
There are six Capturing Tools categories. They are respectively “Iron Cage”, “Bag”, “Net”, “Stun Gun”, “Thieves” and “Wooden Crate”. Each Capturing Tools category has two identical members.
There are a total of 24 Zoo Animals including four “Thieves” who are acting just like animals. They represent respectively the six Animal Groups as follows:
“Big Cats” Group: (1) Lion; (7) Tiger; (13) Leopard and (19) Cougar
“Reptiles” Group: (2) Crocodile; (8) Python; (14) Anaconda and (20) Iguana
“Primates” Group: (3) Gorilla; (9) Orangutan; (15) Pygmy Chimp and (21) Monkey
“Giants” Group: (4) Elephant; (10) Giraffe; (16) Rhino and (22) Hippo
“Thieves” Group: (5) Thief; (11) Thief; (17) Thief and (23) Thief
“Bears” Group: (6) Kodiak Bear; (12) Polar Bear; (18) Panda Bear and (24) Black Bear

Thus there has been described a “Zoo or Bust!” game, both as to organization and method of operation as a preferred embodiment of the present invention. However, many other games can be devised using the concepts set forth in the “Zoo or Bust!” game, or variations thereof. Indeed, because children like familiar games with minor variations, and many children like dinosaurs, Applicant has also developed another game, which Applicant intends to sell under the trademark “CarouSave the Dinosaurs!,” that is very similar to the “Zoo or Bust!” game, except that instead of a zoo, animals and thieves, the game uses a dinosaur park, dinosaurs and poachers, with all of the same rules. The glossary of terms used in playing this game, set forth below, illustrates the differences between the designations found in the three carousel wheels, the board and the chips of this game:

Glossary of Terms Used in Playing the Game

The inner most wheel (1^{st} wheel) is the Dinosaur Groups wheel.
The middle wheel (2^{nd} wheel) is the Capturing Tools wheel.
The outermost wheel (3^{rd} wheel) is the Dinosaurs wheel.
The composite structure of all three wheels is called the Dinosaur Park Carousel.
The Dinosaur Groups wheel has five Dinosaur Group wedges and one Poacher wedge. They are respectively “Purple”, “Blue”, “Green”, “Yellow”, “Orange” and “Poacher”. There are four members in each of the six Dinosaur Groups wedges.
The Capturing Tools wheel has five “Capturing Tool Group” segments and one Poacher segment. They are respectively “Rope Net”, “Wooden Crate”, “Net”, “Iron Cage”, “Stun Gun” and “Poacher”. Each Capturing Tools segment has two identical members.
There are a total of 20 park dinosaurs and four “Poachers”. They represent respectively the five Dinosaur Groups and one Poacher Group as follows:
“Purple” Group: (4) Iguanodon; (10) Triceratops; (16) Parasaurolophus and (22) Corythosaurus
“Blue” Group: (3) Velociraptor; (9) Leptoceratops; (15) Protoceratops and (21) Deinonychus
“Green” Group: (2) Pterodactyl; (8) heterodontosaurus (14) Compsognathus and (20) Bambiraptor
“Yellow” Group: (1) Ankylosaurus; (7) Gallimimus; (13) Stegosaurus and (19) Pachycephalosaurus
“Orange” Group: (6) Brachiosaurus; (12) Brontosaurus; (18) Spinosarus (24) Tryannosaurus
“Poacher” Group: (5) Poacher; (11) Poacher; (17) Poacher and (23) Poacher

Having now described two games that can be played in accordance with the present invention, some additional description will now be given concerning especially preferred embodiments using the carousel wheel.

It has been found that having the inner and outer wheels rotating in a direction opposite the middle wheel is especially pleasing to viewers, and that player anticipation, and thus enjoyment, can be enhanced when the inner wheel stops first, followed by a slight delay, and then the middle wheel stops next, followed by a slight delay, and the then the outer wheel stops last. This result can be accomplished easily enough by a person of ordinary skill in the art of computer programming with the aid of the present disclosure when the carousel is being designed for inclusion on a DVD or CD that can be read by a computer; however, when the carousel is to be used with a DVD player connection to a television set, the task is a little more complicated. The main reason for the difference is that a computer has a processor and memory and the ability to execute a program, whereas a DVD player has very limited memory and does not have the capability of executing a computer program, such as is needed to cause the wheels of the carousel to rotate. Accordingly, when a DVD is to be used with a DVD player for display on a television screen, the DVD, rather than simply using a program that can execute an algorithm associated with spinning the wheels of the carousel, must make such representation by resorting to a series of screen shots that are fixed and burned into the memory of the DVD. Thus, in such a scenario, the “game program” is not a program in the traditional sense of the word of computer programming in which the program can be executed by a computer; instead, the game program resides in the memory of the DVD and the method it uses to point to the next frames in a series of frames used to provide the visual display to the television set.

While it is especially preferred that the “carousel wheel” of the present invention has three wheels that rotate, this is more a matter of aesthetic desirability and appreciation, and thus enjoyment, rather than necessity. Thus, for example, rather than having wheels that “rotate” in a circular fashion, the wheels could have segments in which the segments are shuffled and begin to appear one by one, or all at once for a given wheel. In such a scenario, the concept of a “spin” of a wheel would be fully met by the shuffling process; also, in such a scenario, the order of placement of designations in the wheels could be varied. Thus, for example, instead of having the numbers in the outer wheel progress from 1 through 24 as shown in FIG. 1, the numbers might be randomly (or, more accurately, pseudo randomly) assigned by a computer algorithm. Also, while the present invention discloses a “carousel wheel,” and the dictionary definition of a wheel would probably lead one to conclude that the carousel must be round, such a geometric limitation is not critical to the present invention. Indeed, because the “carousel wheel” is not being physically rotated, but “rotated” electronically, the wheel could take any number of geometric shapes that one might desire, such as a triangle, square, or oval, to name just a few. In any of these shapes, the inner, middle and outer “wheels” can be rotated by movement of the order of the segments of the wheels, or the designations found in the segments, thus giving the appearance of movement or rotation. The important point for a “spin” is that the outcome of the spin, that is where the segments of the wheel end up after the spin, cannot be predicted by a player ahead of time, and that by “spinning” the wheel it appears that any possible combination of results is possible for a given spin. Also, for this to happen, the various wheels must “rotate” or “spin” independently of each other, so that the relationships of the segments of the various wheels one to anther can also vary for a given “spin.”

While the invention has been described herein with reference to one preferred embodiment set forth in the “Zoo or Bust!” game, this embodiment has been presented by way of example only, and not to limit the scope of the invention. Additional embodiments thereof will be obvious to those skilled in the art having the benefit of this detailed description. Further modifications are also possible in alternative embodiments without departing from the inventive concept. For example, although it is believed that it would be far less aesthetically desirable, there is no reason why all of the segments need necessarily be of equal sizes, or why they would have to precisely line up when forming a player session spin set of designations, and such minor departures from the description of the preferred embodiment do not fall outside of the scope of the present invention.

Accordingly, it will be apparent to those skilled in the art that still further changes and modifications in the actual concepts described herein can readily be made without departing from the spirit and scope of the disclosed inventions as defined by the following claims.

What is claimed is:

1. A game apparatus, comprising:
a board with twenty different indicia divided into five groups;
a first set of twenty markers, each of the markers bearing a different one of the twenty indicia and a unique correlation marking matched to one of the twenty different indicia; and
a storage medium containing a game program, wherein the game program, when activated, will generate a screen comprising:
a carousel wheel with an inner wheel divided into six inner wheel segments, each of which bears an inner wheel designation; a middle wheel divided into twelve segments, each of which bears a middle wheel designation; and an outer wheel divided into twenty-four outer equal segments, each of which bears an outer wheel designation;
wherein five of the inner wheel designations are each matched to a different one of the five groups;
wherein ten of the middle wheel designations are matched to the five groups so that each of the five groups is matched by two of the middle wheel designations;
wherein twenty of the outer wheel designations are matched to a different one of the unique correlation markings; and
wherein the carousel can be spun by a player during a player's turn so that each of the inner, the middle and the outer wheels rotate for a given spin so that once the carousel is spun, and each of inner, the middle and the outer wheels have rotated, said wheels will stop such that each of the inner wheel segments will align itself moving outwardly from the inner wheel with two of the middle wheel segments and four of the outer wheel segments.

2. The game apparatus of claim 1, further comprising:
one or more additional sets of twenty markers, each of the markers bearing a different one of the twenty indicia and a unique correlation marking matched to one of the twenty different indicia.

3. The game apparatus of claim 2, wherein the first set of the markers and each of the one or more additional sets of twenty markers bear a unique color designations to distinguish the sets of markers from one another.

4. The game apparatus of claim 1, wherein the twenty different indicia are animals.

5. The game apparatus of claim 4, wherein the animal indicia of each of the groups are linked together by a common characteristic.

6. The game apparatus of claim 5, wherein the inner wheel designations include the common characteristic.

7. The game apparatus of claim 6, wherein the middle wheel designations for each of the five groups include a second common characteristic associated with that group.

8. The game apparatus of claim 1, wherein a sixth inner wheel designation that is not matched to any of the five groups is matched to two middle wheel designations that are not matched to any of the five groups and four of the outer wheel designations that are not matched to any of the unique correlation markings.

9. The game apparatus of claim 1, wherein the storage medium is a DVD and the game program can be played by use of a DVD player so that the carousel wheel is visible on a television screen.

10. The game apparatus of claim 1, wherein the storage medium is an optical storage disc and the game program can be played by use of a computer so that the carousel wheel is visible on a screen receiving an input from the computer.

11. The game apparatus of claim 1, wherein the twenty different indicia are dinosaurs.

12. A method of playing a game by two or more players in which groups of markers may be collected by a player during a player's turn and the players take turns spinning a carousel wheel with an inner wheel divided into x inner wheel segments, each of which bears an inner wheel designation, a middle wheel divided into y segments, each of which bears a middle wheel designation, and an outer wheel divided into z outer equal segments, each of which bears an outer wheel designation, wherein y is greater than or equal to x, z is greater than or equal to y and both y and z are divisible by x, comprising the steps of:
(1) allowing a designated player to spin the carousel wheel;
(2) determining if the designated player has an action match based upon a preselected group of inner, middle and outer wheel designations for the designated player for the designated player's spin and then proceeding to step (3) if there is no action match or to step (4) if there is an action match;
(3) if the designated player does not have an action match, alternating who is the designated player amongst the two or more players and then repeating steps (1) and (2);
(4) if the designated player does have an action match, then applying a set of action match rules to determine whether the designated player gains or loses one or more markers; and
(5) either declaring the designated player a winner if the designated player has accumulated a winning collection of markers or alternating who is the designated player amongst the two or more players and then repeating steps (1) and (2).

13. The method of claim 12, wherein the carousel wheel can be spun so that each of the inner, the middle and the outer wheels rotate independently of one another and after the carousel wheel is spun, and each of inner, the middle and the outer wheels have rotated, said wheels will stop such that one of the inner wheel segments will align itself moving outwardly from the inner wheel with (y divided by x) of the middle wheel segments and with (z divided by x) of the outer wheel segments.

14. The method of claim 13, wherein x is equal to 6, y is equal to 12 and z is equal to 24.

15. The method of claim 14, wherein the inner wheel designations are comprised of five different group designations and a sixth inner wheel designation that is not matched to any of the five groups, wherein the middle wheel designations are comprised of ten middle wheel designations that are matched to the five groups so that each of the five groups is matched by two of the middle wheel designations and two middle wheel designations that are not matched to any of the five groups, wherein the outer wheel designations are comprised of twenty unique outer wheel designations that are matched to the five groups so that each of the five groups is matched to four of the outer wheel designations and four outer wheel designations that are not matched to any of the five groups, and wherein the preselected group consists of one inner wheel designation, two middle wheel designations and four outer wheel designations.

16. The method of claim 15, wherein the action match is an award match when the preselected group contains an inner wheel group designation and both a middle wheel designation and an outer wheel designation matched to the inner wheel group designation and the player receives an award marker that matches the outer wheel designation for the action match.

17. The method of claim 16, wherein the action match is a misfortune match when the preselected group contains the sixth inner wheel designation, one of the two middle wheel designations that are not matched to any of the five groups and none of the four outer wheel designations that are not matched to any of the five groups and the designated player must surrender any markers that match any of the four outer wheel designations in the preselected group.

18. The method of claim 17, wherein the action match is a special misfortune match when the preselected group contains the sixth inner wheel designation, one of the two middle wheel designations that are not matched to any of the five groups and one of the four outer wheel designations that are not matched to any of the five groups and the designated player must surrender all of the designated player's markers.

19. The method of claim 17, wherein the action match is a special misfortune match when the preselected group contains the sixth inner wheel designation, one of the two middle wheel designations that are not matched to any of the five groups and one of the four outer wheel designations that are not matched to any of the five groups and the designated player can choose one or more markers from one or more of the other players.

20. The method of claim 12, wherein the players are allowed to select one or more rules to be applied when there is an action match.
